(19) United States
(12) Patent Application Publication
(10) Pub. No.: US 2005/0023732 A1
(43) Pub. Date: Feb. 3, 2005

(54) Mold mounted drop cylinder assembly

(76) Inventors: Alan Belton, Clwyd (GB); David Humphreys, Clwyd (GB)

Correspondence Address: VENABLE, BAETJER, HOWARD AND CIVILETTI, LLP, P.O. BOX 34385, WASHINGTON, DC, 20043-9998, US

(21) Appl. No.: 10/494,436

(22) PCT Filed: Aug. 1, 2003
(86) PCT No.: PCT/US03/24017

(51) Int. Cl. B29C 49/70

(52) U.S. Cl. 264/334; 425/537; 425/444

(57) ABSTRACT

A system is provided for removing a molded product from a mold of a blow molding machine. The mold has a first half with first and second knockout heads. The system has a first rod for engaging the first knockout head, a second rod for engaging the second knockout head, and a first actuator that engages the first and second rods and positively controls movement of the first and second rods in a first direction and a second direction opposite the first direction. The first rod, the second rod and the first actuator mount on the first half of the mold such that the first rod, the second rod and the first actuator move with the first half of the mold when the mold is in operation.

### BACKGROUND OF THE INVENTION

The invention relates to blow molding machines. More particularly, the invention relates to systems for removing molded products from blow molding machine molds.

Many plastic containers are produced today using blow mold techniques. Many blow mold machines are provided with systems for removing the molded products from the mold after molding. Some of these systems include knockout heads that are pushed against a waste portion of the molded product as the molds are opened to push the molded product away from the mold. Various problems can result from molded products that are released from the mold in anything other than an ideal fashion. These problems can be particularly severe in a dual parison molding process.

In a dual parison molding process, each mold contains, for example, two parallel mold cavities in which molded products are simultaneously created. Proper, controlled release of the molded products from dual parison blow mold machines is particularly important.

### SUMMARY OF THE INVENTION

The invention provides a solution to the above described problems by providing a system for removing a molded product from a mold of a blow molding machine, the mold having a first half with first and second knockout heads. The system has a first rod for engaging the first knockout head, a second rod for engaging the second knockout head, and a first actuator that engages the first and second rods and positively controls movement of the first and second rods in a first direction and a second direction opposite the first direction. The first rod, the second rod and the first actuator are for mounting on the first half of the mold such that the first rod, the second rod and the first actuator move with the first half of the mold when the mold is in operation.

Other embodiments of the invention provide a method of removing a molded product from a mold of a blow molding machine, the mold having a first half with first and second knockout heads. The method includes engaging the first knockout head with a first rod mounted on the first half of the mold, engaging the second knockout head with a second rod mounted on the first half of the mold, engaging the first and second rods with a first actuator mounted on the first half of the mold; and with the first actuator, positively controlling movement of the first and second rods in a first direction and a second direction opposite the first direction. The first rod, the second rod and the first actuator move with the first half of the mold when the mold is in operation.

### BRIEF DESCRIPTION OF THE DRAWINGS

The invention is explained below in further detail with the aid of exemplary embodiments shown in the drawings, wherein:

FIG. 1 is a top view of a first embodiment of the invention in a retracted position;

FIG. 2 is a top view of the embodiment shown in FIG. 1 in an extended position;

FIG. 3 is a side view of an embodiment of the invention using two of the embodiments shown in FIGS. 1 and 2; and

FIG. 4 is an embodiment of the invention using two of the embodiments shown in FIG. 3.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

The drawings show examples of the invention that can be applied to a dual parison blow mold wheel machine. In such a machine, a plurality, for example twenty-four, molds are positioned around the circumference of the wheel, each mold having two halves and opening in a direction parallel to the axis of the wheel. The products formed in the molds often require some sort of force to remove the products from the molds.

One method of removing the product formed in the mold is to push the product from the mold by way of a knockout head or knockout heads pressing against a waste portion of the product when the mold is opened.

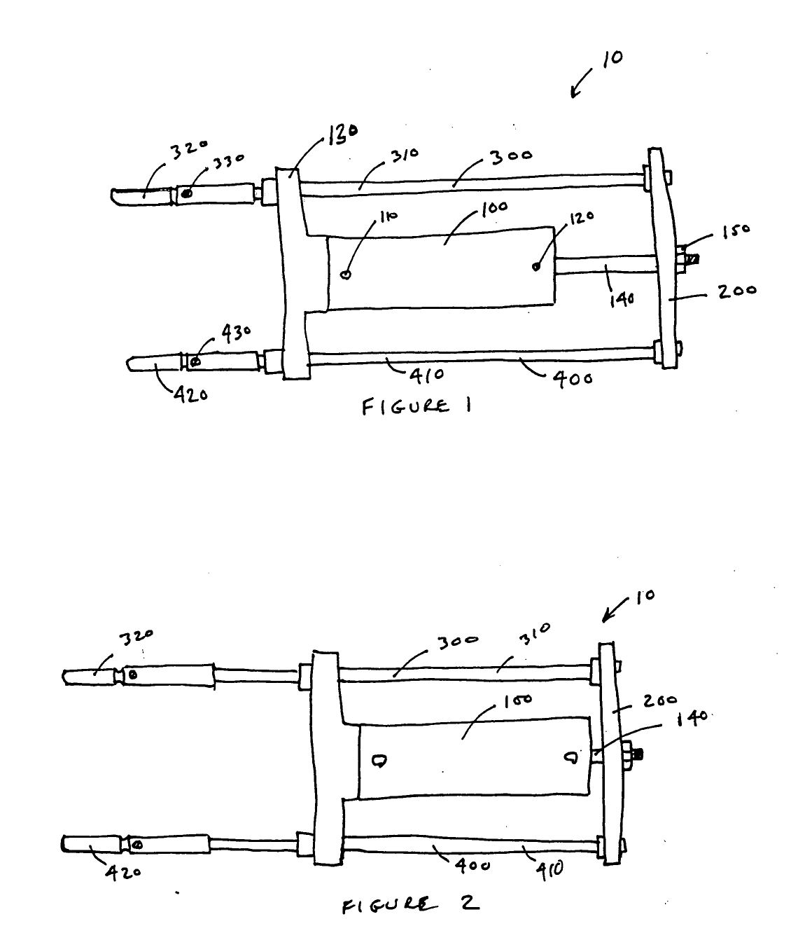

FIGS. 1 and 2 show an embodiment of the invention used to subject the waste portion to force such that the molded product is ejected from the mold when the mold halves are opened. FIG. 1 is a top view of a dual-rod actuator assembly 10 in accordance with the invention. FIG. 1 shows actuator assembly 10 in a retracted position. Actuator assembly 10 would take the retracted position during the molding process when the mold halves are closed. Actuator assembly 10 has an actuator 100 fixed to a support frame 130. Actuator 100 has a first inlet 110 and a second inlet 120 through which a pressurized fluid (air, oil, etc.) is introduced to, and removed from, actuator 100 to cause actuator shaft 140 to move side to side in FIG. 1. Actuator shaft 140 is attached to a tie bar 200 by, for example, a nut 150. As a result, as actuator shaft 140 moves under the pressure of fluid introduced to either first inlet 110 or second inlet 120, tie bar 200 also moves. A first knockout rod assembly 300 and a second knockout rod assembly 400 are each fixed to tie bar 200 at one end. First knockout rod assembly 300 has a first knockout rod 310 which is attached to tie bar 200 at one end and has a first knockout head 320 at its other end. First knockout head 320 is attached to first knockout rod 310 by, for example, a threaded connection. A depression or hole 330 can be provided in first knockout head 320 to facilitate gripping first knockout head 320 during assembly with first knockout rod 310. Similarly, second knockout rod assembly 400 has a second knockout rod 410 that is attached to tie bar 200 at one end and has a second knockout head 420 at its other end. Second knockout head 420 is attached to second knockout rod 410 by, for example, a threaded connection. A depression or hole 430 can be provided in first knockout head 420 to facilitate gripping first knockout head 420 during assembly with first knockout rod 410.

FIG. 2 shows actuator assembly 10 in an extended position such as the position used to push molded products from a mold after formation. In one application, support frame 130 is fixed to mold half (shown in FIG. 4) such that movement of tie bar 200 and rod assemblies 300, 400 relative to actuator 100 results in movement of knockout heads 320, 420 relative to the mold half. In FIG. 2, due to the movement of actuator shaft 140 by actuator 100, tie bar 200 is moved relative to actuator 100 (to the left in FIG. 2). This causes knockout rods 310, 410 and, therefore, knockout heads 320, 420 to move relative to actuator 100 (also to the left in FIG. 2).

As support frame 130 is fixed to a mold half, movement of actuator assembly 10 from the position shown in FIG. 1 to the position shown in FIG. 2 causes knockout heads 320, 420 to press against waste portions of a molded product in the mold.

In dual parison molding the mold has two mold cavities. Each mold cavity forms a log containing at least one molded product. Each log usually has a waste portion at each of its ends against which knockout heads can act. As a result, a dual parison mold will usually use four knockout heads on each half of the mold.

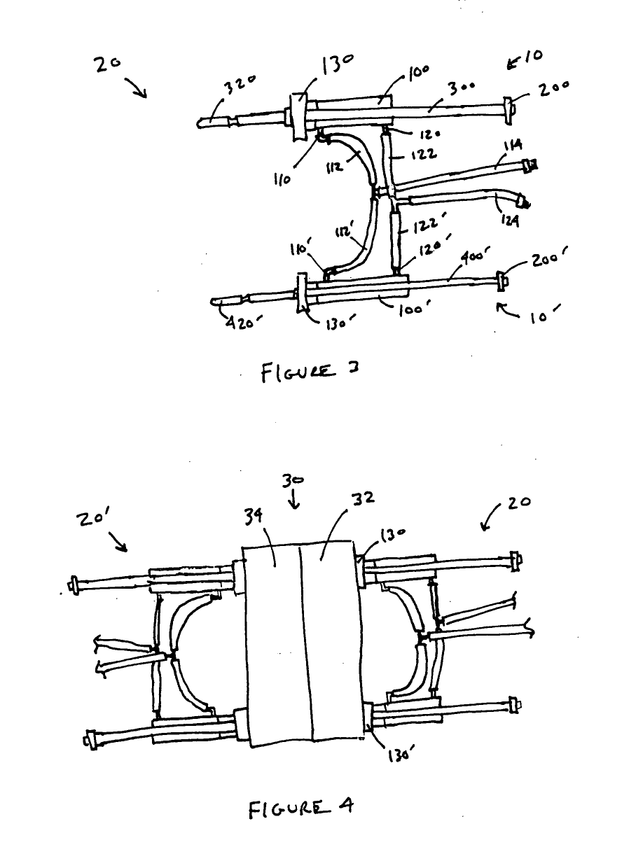

FIG. 3 shows a double dual-rod actuator assembly 20 in accordance with the invention. Assembly 20 includes two dual-rod actuator assemblies 10, 10′ as shown in FIG. 1. Dual-rod actuator assemblies 10, 10′ are shown in side elevation view in FIG. 3. Elements 100′, 110′, 120′, 130′, 200′, 400′ and 420′ of dual-rod actuator assembly 10′ correspond to the similarly numbered elements of dual-rod actuator assembly 10. First inlet 110 of actuator assembly 10 and first inlet 110′ of actuator assembly 10′ are connected to a first inlet supply 114 by first inlet hoses 112, 112′, respectively. Similarly, second inlet 120 of actuator assembly 10 and second inlet 120′ of actuator assembly 10′ are connected to a second inlet supply 124 by second inlet hoses 120, 120′. By selectively introducing pressurized fluid to inlet supplies 114, 124, actuators 100, 100′ are activated, resulting in the coordinated movement of four knockout heads. The embodiments shown in FIG. 3 allows four knockout heads to be moved in unison to more precisely control the ejection of a molded product from the mold.

As stated above, double dual-rod actuator assembly 20 is fixed to one half of a mold. As shown in FIG. 4, double dual-rod actuator assembly 20 is fixed to first mold half 32 of a mold 30. Similarly, a second double dual-rod actuator assembly 20′ is fixed to a second mold half 34 of mold 30. When mold halves 32, 34 are separated from each other, the four actuators of the double dual-rod actuator assemblies 20, 20′ are subjected to the pressurized air to press the eight knockout heads against the waste portions of the logs to eject the logs from mold 30.

Although the invention has been described using a dual parison machine that produces two logs, it is noted that the invention is applicable to mold machines that produce any number of logs. Further, based on the teachings herein, the invention can be applied to machines requiring any number of knockout heads per actuator.

The invention has been described in detail with respect to preferred embodiments and it will now be apparent from the foregoing to those skilled in the art that changes and modifications may be made without departing from the invention in its broader aspects. The invention, therefore, is intended to cover all such changes and modifications that fall within the true spirit of the invention.

1. A system for removing a molded product from a mold of a blow molding machine, the mold having a first half with first and second knockout heads, the system comprising:
a first rod for engaging the first knockout head;
a second rod for engaging the second knockout head;
a first actuator that engages the first and second rods and positively controls movement of the first and second rods in a first direction and a second direction opposite the first direction,
wherein the first rod, the second rod and the first actuator are for mounting on the first half of the mold such that the first rod, the second rod and the first actuator move with the first half of the mold when the mold is in operation.

2. The system of claim 1, further comprising a tie bar that operatively associates the first rod with the second rod such that the first and second rods move ir unison.

3. The system of claim 1, wherein the first half of the mold has a first cavity and a second cavity,
the first knockout head interacts with the first cavity, and
the second knockout head interacts with the second cavity.

4. The system of claim 1, wherein the first half of the mold has a third knockout head and a fourth knockout head, the system further comprising:
a third rod for engaging the third knockout head;
a fourth rod for engaging the fourth knockout head; and
a second actuator that engages the third and fourth rods and positively controls movement of the third and fourth rods in a third direction and a fourth direction opposite the third direction,
wherein the third rod, the fourth rod and the second actuator are for mounting on the first half of the mold such that the third rod, the fourth rod and the second actuator move with the first half of the mold when the mold is in operation.

5. The system of claim 4, wherein the first half of the mold has a first cavity and a second cavity,
the first and third knockout heads interact with the first cavity, and
the second and fourth knockout heads interact with the second cavity.

6. The system of claim 5, wherein the third direction is the first direction and the fourth direction is the second direction.

7. The system of claim 5, wherein the mold has a second half, the second half having a first cavity that corresponds to the first cavity of the first half and a second cavity that corresponds to the second cavity of the first half, the first cavity of the second half having fifth and seventh knockout heads, the second cavity of the second half having sixth and eighth knockout heads, the system further comprising:
a fifth rod for engaging the fifth knockout head;
a sixth rod for engaging the sixth knockout head;
a third actuator that engages the fifth and sixth rods and positively controls movement of the fifth and sixth rods in the first direction and the second direction;
a seventh rod for engaging the seventh knockout head;
an eighth rod for engaging the eighth knockout head; and
a fourth actuator that engages the seventh and eighth rods and positively controls movement of the seventh and eighth rods in the third direction and the fourth direction,
wherein the fifth, sixth, seventh and eighth rods and the third and fourth actuators are for mounting on the second half of the mold such that the fifth, sixth, seventh and eighth rods and the third and fourth actuators move with the second half of the mold when the mold is in operation.

8. The system of claim 1, wherein the first actuator moves the first rod and the second rod in unison.

9. The system of claim 8, further comprising a controller, the controller controlling the first and second actuators such that the first, second, third and fourth rods are moved in unison.

10. A method of removing a molded product from a mold of a blow molding machine, the mold having a first half with first and second knockout heads, the method comprising:
engaging the first knockout head with a first rod mounted on the first half of the mold;
engaging the second knockout head with a second rod mounted on the first half of the mold;
engaging the first and second rods with a first actuator mounted on the first half of the mold; and
with the first actuator, positively controlling movement of the first and second rods in a first direction and a second direction opposite the first direction,
wherein the first rod, the second rod and the first actuator move with the first half of the mold when the mold is in operation.

11. The method of claim 10, wherein the first actuator positively controls the movement of the first and second rods through a tie bar such that the first and second rods move in unison.

12. The method of claim 10, wherein the first half of the mold has a first cavity and a second cavity,
the first knockout head interacts with the first cavity, and
the second knockout head interacts with the second cavity.

13. The method of claim 10, wherein the first half of the mold has a third knockout head and a fourth knockout head, the method further comprising:
engaging the third knockout head with a third rod mounted on the first half of the mold;
engaging the fourth knockout head with a fourth rod mounted on the first half of the mold;
engaging the third and fourth rods with a second actuator mounted on the first half of the mold; and
with the second actuator, positively controlling movement of the third and fourth rods in a third direction and a fourth direction opposite the third direction,
wherein the third rod, the fourth rod and the second actuator move with the first half of the mold when the mold is in operation.

14. The method of claim 13, wherein the first half of the mold has a first cavity and a second cavity,
the first and third knockout heads interact with the first cavity, and
the second and fourth knockout heads interact with the second cavity.

15. The method of claim 14, wherein the third direction is the first direction and the fourth direction is the second direction.

16. The method of claim 14, wherein the mold has a second half, the second half having a first cavity that corresponds to the first cavity of the first half and a second cavity that corresponds to the second cavity of the first half, the first cavity of the second half having fifth and seventh knockout heads, the second cavity of the second half having sixth and eighth knockout heads, the method further comprising:
engaging the fifth knockout head with a fifth rod mounted on the second half of the mold;
engaging the sixth knockout head with a sixth rod mounted on the second half of the mold;
engaging the fifth and sixth rods with a third actuator mounted on the second half of the mold;
with the third actuator, positively controlling movement of the fifth and sixth rods in the first direction and the second direction;
engaging the seventh knockout head with a seventh rod mounted on the second half of the mold;
engaging the eighth knockout head with an eight rod mounted on the second half of the mold; and
engaging the seventh and eighth rods with a fourth actuator mounted on the second half of the mold; and
with the fourth actuator, positively controlling movement of the seventh and eighth rods in the third direction and the fourth direction,
wherein the fifth, sixth, seventh and eighth rods and the third and fourth actuators move with the second half of the mold when the mold is in operation.

17. The method of claim 16, wherein the first actuator moves the first rod and the second rod in unison.

18. The method of claim 17, further comprising controlling the first, second, third and fourth actuators with a controller such that the first, second, third, fourth, fifth, sixth, seventh and eighth rods are moved in unison.

19. The method of claim 10, wherein the first actuator moves the first rod and the second rod in unison.

20. The method of claim 19, further comprising controlling the first and second actuators with a controller such that the first, second, third and fourth rods are moved in unison.
